(19) United States
(12) Patent Application Publication
(10) Pub. No.: US 2024/0311988 A1
(43) Pub. Date: Sep. 19, 2024

(54) DEFECT CLASSIFICATION METHOD AND DEFECT CLASSIFICATION SYSTEM

(71) Applicant: Samsung Display Co., LTD., Yongin-si (KR)

(72) Inventors: JUNSU PARK, Yongin-si (KR); NAMHYUK KIM, Yongin-si (KR); SANGJUN SEOK, Yongin-si (KR)

(21) Appl. No.: 18/395,525

(22) Filed: Dec. 23, 2023

(30) Foreign Application Priority Data
Mar. 15, 2023 (KR) 10-2023-0034165

(51) Int. Cl. G06T 7/00; G01N 21/95; G06T 7/73; G06V 10/75; G06V 10/764; G06V 10/774; G06V 10/82

(52) U.S. Cl. CPC G06T 7/0002; G01N 21/95; G06T 7/74; G06V 10/751; G06V 10/764; G06V 10/774; G06V 10/82; G06T 2207/10101; G06T 2207/20081; G06T 2207/20084; G06T 2207/30108

(57) ABSTRACT

A defect classification method includes collecting a first image of an exterior of a display device; determining a defect of the display device based on the first image; extracting XY coordinates of the defect of the display device; collecting a second image of an inside of the display device based on the XY coordinates of the defect of the display device; training a deep machine learning model for determining the defect of the display device and a defect type of the display device based on the second image; determining the defect of the display device based on the second image through the deep machine learning model; and determining the defect type of the display device based on the second image through the deep machine learning model.

This application claims priority to Korean Patent Application No. 10-2023-0034165, filed on Mar. 15, 2023, and all the benefits accruing therefrom under 35 U.S.C. § 119, the content of which in its entirety is herein incorporated by reference.

### BACKGROUND

### 1. Field

Embodiments of the inventive concept relate to a defect classification method and a defect classification system. More particularly, embodiments of the inventive concept relate to a defect classification method and a defect classification system for classifying a defect of a display device.

### 2. Description of the Related Art

A defect of a display device may occur in manufacturing process. A conventional defect classification system determines an exterior defect of the display device by a multi-optical vision device, and then a human determines whether the exterior defect is a false defect or a true defect by a microscope or the like. judged specifically. Here, the false defect means a case where the multi-optical vision device determines that a good product has the defect, and the true defect means a case where the multi-optical vision device determines that a defective product has the defect. In addition, when the exterior defect is the true defect, the human determines a defect type of the display device.

### SUMMARY

When the human determines whether the exterior defect is the false defect or the true defect, a defect inspection and a defect classification may demand a long time.

Embodiments of the inventive concept provide a defect classification method for determining a defect and a defect type of a display device by a deep machine learning model.

Embodiments of the inventive concept provide a defect classification system for performing the defect classification method.

In an embodiment of a defect classification method according to the inventive concept, the defect classification method includes collecting a first image of an exterior of a display device by a multi-optical vision device; determining a defect of the display device based on the first image by the multi-optical vision device; extracting XY coordinates of the defect of the display device; collecting a second image of an inside of the display device based on the XY coordinates of the defect of the display device by an optical coherence tomography device; training a deep machine learning model for determining the defect of the display device and a defect type of the display device based on the second image by the optical coherence tomography device; determining the defect of the display device based on the second image through the deep machine learning model by the optical coherence tomography device; and determining the defect type of the display device based on the second image through the deep machine learning model by the optical coherence tomography device.

In an embodiment, when it is determined that the display device does not include the defect based on the first image by the multi-optical vision device, defect inspection for the display device may be terminated.

In an embodiment, when it is determined that the display device does not include the defect based on the second image by the optical coherence tomography device, defect inspection for the display device may be terminated.

In an embodiment, the deep machine learning model for determining the defect of the display device and the defect type of the display device may be trained based on the first image and the second image by the optical coherence tomography device.

In an embodiment, the deep machine learning model may include a convolutional neural network (“CNN”).

In an embodiment, the CNN may include a convolutional layer, a pooling layer, and a fully connected layer.

In an embodiment, the pooling layer may include a max pooling layer.

In an embodiment, the pooling layer may include an average pooling layer.

In an embodiment, the second image may include information on a foreign substance and layers in a stacked structure of the display device.

In an embodiment, the second image may include a B-scan image.

In an embodiment, the second image may include a C-scan image.

In an embodiment, the defect of the display device and the defect type of the display device may be determined based on the first image through the deep machine learning model by the multi-optical vision device.

In an embodiment of a defect classification system according to the inventive concept, the defect classification system includes a multi-optical vision device which collects a first image of an exterior of a display device, determine a defect of the display device based on the first image, and extract XY coordinates of the defect of the display device; and an optical coherence tomography device which collects a second image of an inside of the display device based on the XY coordinates of the defect of the display device, train a deep machine learning model for determining the defect of the display device and a defect type of the display device based on the second image, determine the defect of the display device based on the second image through the deep machine learning model, and determine the defect type of the display device based on the second image through the deep machine learning model.

In an embodiment, the deep machine learning model for determining the defect of the display device and the defect type of the display device may be trained based on the first image and the second image by the optical coherence tomography device.

In an embodiment, the deep machine learning model may include a CNN.

In an embodiment, the CNN may include a convolutional layer, a pooling layer, and a fully connected layer.

In an embodiment, the pooling layer may include a max pooling layer.

In an embodiment, the pooling layer may include an average pooling layer.

In an embodiment, the second image may include information on a foreign substance and layers in a stacked structure of the display device.

In an embodiment, the second image may include a B-scan image.

According to the defect classification method and the defect classification system in the embodiments, by the multi-optical vision device, the defect of the display device may be determined based on the first image of the exterior of the display device 100, and the XY coordinates of the defect of the display device may be extracted and by the optical coherence tomography device, the deep machine learning model for determining the defect of the display device and the defect type of the display device may be trained based on the XY coordinates of the defect of the display device and the second image of the inside of the display device so that accuracy of the defect inspection and defect classification may be increased, and a time desired for the defect inspection and the defect classification may be reduced.

### BRIEF DESCRIPTION OF THE DRAWINGS

The above and other features of embodiments of the inventive concept will become more apparent by describing in detailed embodiments thereof with reference to the accompanying drawings, in which:

FIG. 1 is a flowchart showing an embodiment of a defect classification method for determining a defect and a defect type of a display device by a deep machine learning model;

FIG. 2 is a block diagram showing an embodiment of a multi-optical vision device according to the inventive concept;

FIG. 3 is a conceptual diagram showing a structure of a display device;

FIG. 4 is a view showing a first image captured by the multi-optical vision device of FIG. 2;

FIG. 5 is a block diagram showing an embodiment of an optical coherence tomography device according to the inventive concept;

FIG. 6 is a conceptual diagram showing a B-scan image collected by the optical coherence tomography device of FIG. 5;

FIG. 7 is a conceptual diagram showing a C-scan image collected by the optical coherence tomography device of FIG. 5; and

FIG. 8 is a view showing a second image captured by the optical coherence tomography device of FIG. 5.

### DETAILED DESCRIPTION

Hereinafter, embodiments of the inventive concept will be described in detail with reference to the accompanying drawings.

The invention now will be described more fully hereinafter with reference to the accompanying drawings, in which various embodiments are shown. This invention may, however, be embodied in many different forms, and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “on” another element, it can be directly on the other element or intervening elements may be present therebetween. In contrast, when an element is referred to as being “directly on” another element, there are no intervening elements present.

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

The terminology used herein is for the purpose of describing particular embodiments only and is not intended to be limiting. As used herein, the singular forms “a,” “an,” and “the” are intended to include the plural forms, including “at least one,” unless the content clearly indicates otherwise. “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). The term such as “about” can mean within one or more standard deviations, or within ±30%, 20%, 10%, 5% of the stated value, for example.

The term such as “controller” as used herein is intended to mean a software component or a hardware component that performs a predetermined function. The hardware component may include a field-programmable gate array (“FPGA”) or an application-specific integrated circuit (“ASIC”), for example. The software component may refer to an executable code and/or data used by the executable code in an addressable storage medium. Thus, the software components may be object-oriented software components, class components, and task components, and may include processes, functions, attributes, procedures, subroutines, segments of program code, drivers, firmware, micro codes, circuits, data, a database, data structures, tables, arrays, or variables, for example.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

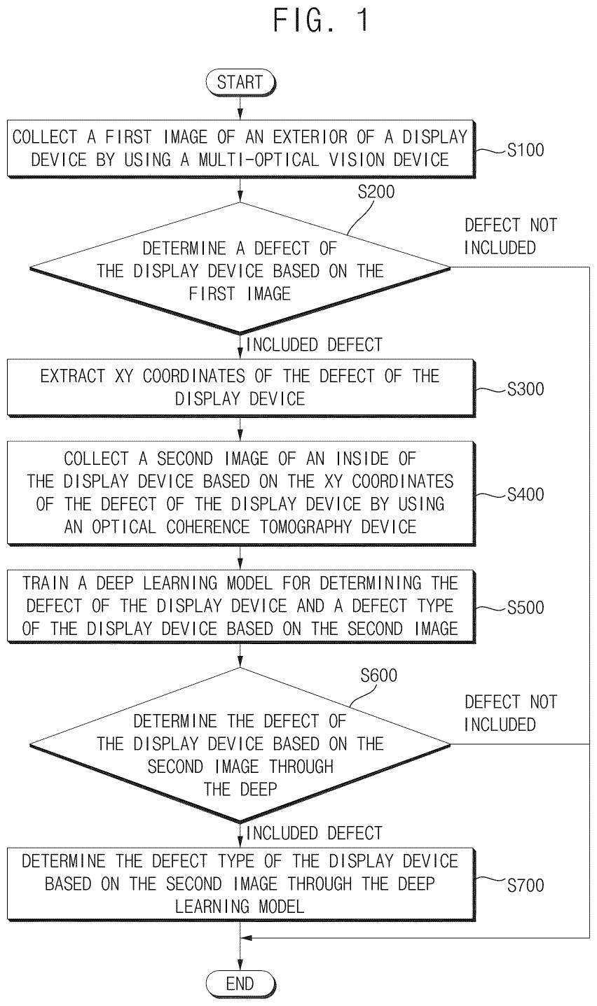

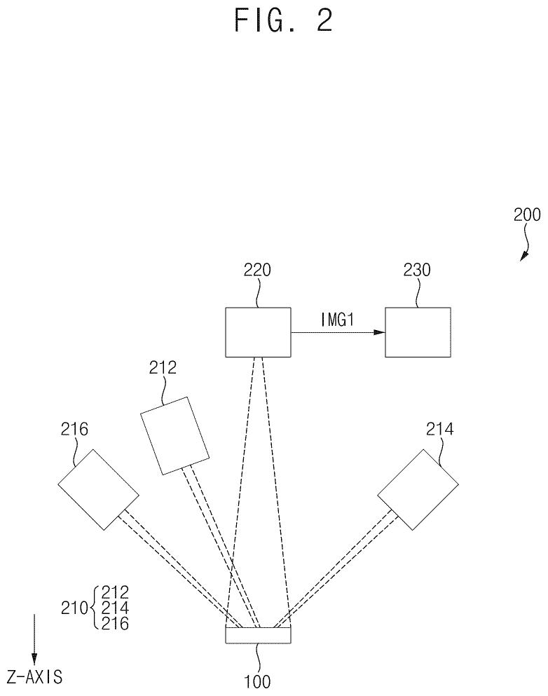

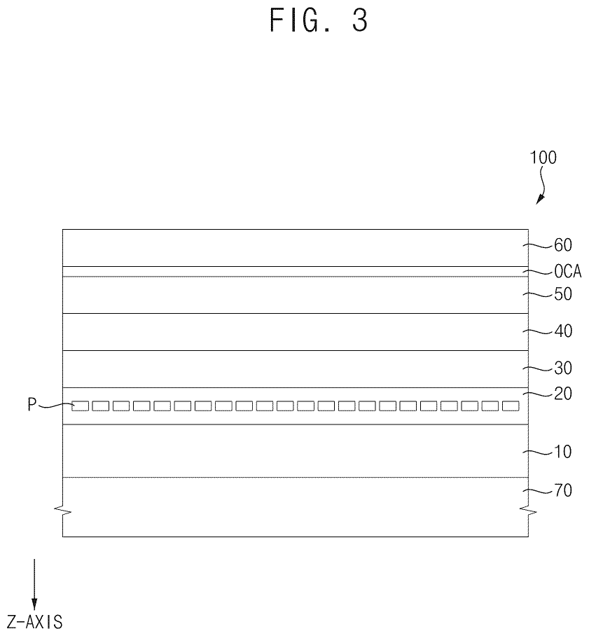

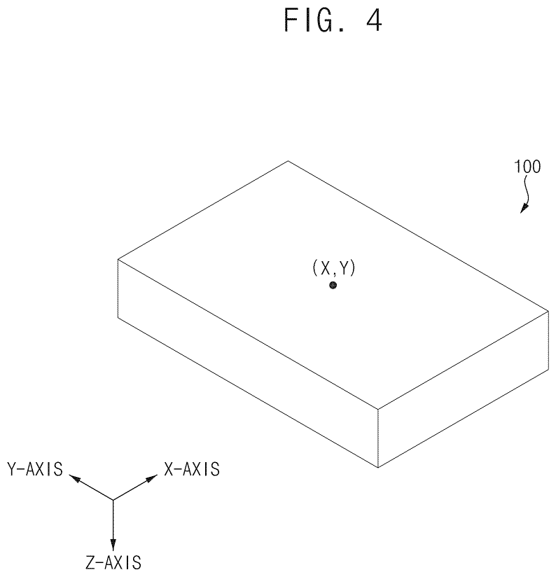

FIG. 1 is a flowchart showing a defect classification method for determining a defect and a defect type of a display device by a deep machine learning model. FIG. 2 is a block diagram showing an embodiment of a multi-optical vision device according to the inventive concept. FIG. 3 is a conceptual diagram showing a structure of a display device. FIG. 4 is a view showing a first image captured by the multi-optical vision device of FIG. 2.

Referring to FIGS. 1 and 4, a defect classification method may include: collecting a first image IMG1 of an exterior of a display device 100 by a multi-optical vision device 200 (S100); determining a defect of the display device 100 based on the first image IMG1 by the multi-optical vision device 200 (S200); and extracting XY coordinates of the defect of the display device 100 (S300).

A defect classification system may include the multi-optical vision device 200 and an optical coherence tomography device. The multi-optical vision device 200 may include a first lighting device 210, an image capturing device (e.g., camera) 220, and a controller 230.

The first lighting device 210 may emit a light to determine the defect of the display device 100. The first lighting device 210 may include a dark field lighting device 212, a bright field lighting device 214, and a differential field lighting device 216. The dark field lighting device 212, the bright field lighting device 214, and the differential field lighting device 216 may be classified according to an emission angle of the light and a reflection angle of the light from the display device 100. Emission angles and emission brightness of the dark field lighting device 212, the bright field lighting device 214, and the differential field lighting device 216 may vary according to physical properties of the display device 100. The dark field lighting device 212, the bright field lighting device 214, and the differential field lighting device 216 may be configured such that an interval between installation positions of the lighting devices may vary according to an angle of view of the camera 220. The above configuration may be made to minimize interference of lights by maintaining an interval between emission regions to which the lights are emitted from the lighting devices. Since the multi-optical vision device 200 includes three types of lighting devices, images of optical features, such as a bright field image, a dark field image, and a differential field image, may be obtained through single image capturing without lighting device control or lighting device synchronization. Accordingly, accuracy of defect inspection of the display device 100 may be increased by complementary images.

The dark field lighting device 212 may emit the light such that the defect of the display device 100 may appear bright, and a periphery of the defect may appear dark. Although a lighting device angle and a lighting device wavelength of the dark field lighting device 212 may vary according to the physical properties of the display device 100, the lighting device angle of the dark field lighting device 212 may be preset such that diffuse reflection may occur in the defect.

The bright field lighting device 214 may emit the light such that the defect of the display device 100 may appear dark, and the periphery of the defect may appear bright. Although a lighting device angle and a lighting device wavelength of the bright field lighting device 214 may vary according to the physical properties of the display device 100, the lighting device angle of the bright field lighting device 214 may be preset such that specular reflection may occur in the defect.

The differential field lighting device 216 may emit the light such that the entirety of the display device 100 may appear bright, and a shade may be generated in the defect. Although a lighting device angle and a lighting device wavelength of the differential field lighting device 216 may vary according to the physical properties of the display device 100, the lighting device angle of the differential field lighting device 216 may be preset such that the interference of the lights may occur in the defect to have a three-dimensional appearance.

The image capturing device 220 may capture an image of the display device 100 to which the lights are simultaneously emitted from the positions of the first lighting device 210. A capturing region of the display device 100 may be preset by the angle of view, and the image capturing device 220 may generate the first image IMG1 including a dark field capturing region, a bright field capturing region, and a differential field capturing region. In this case, the dark field capturing region, the bright field capturing region, and the differential field capturing region may maintain a preset interval to minimize the interference of the lights emitted thereto. The image capturing device 220 may output the first image IMG1 to the controller 230. Howe

The display device 100 may include a substrate 10, a display layer 20 disposed on the substrate 10, an encapsulation layer 30 disposed on the display layer 20, an input sensing layer 40 disposed on the encapsulation layer 30, an optical functional layer 50 disposed on the input sensing layer 40, an adhesive layer OCA disposed on the optical function layer 50, and a window 60 disposed on the adhesive layer OCA. A lower protective film 70 may be disposed under the substrate 10. The display layer 20 may include pixels P.

The first image IMG1 may be an image of the exterior of the display device 100. In an embodiment, the multi-optical vision device 200 may determine defects of the window 60 and the adhesive layer OCA through the first image IMG1, for example.

The controller 230 may determine the defect of the display device 100 based on the first image IMG1.

In an embodiment, when the controller 230 determines that the display device 100 does not include the defect based on the first image IMG1, the defect inspection of the display device 100 may be terminated.

The controller 230 may determine that the display device 100 includes the defect based on the first image IMG1. As shown in FIG. 4, the controller 230 may extract the XY coordinates (an X coordinate and a Y coordinate) of the defect of the display device 100. The X coordinate may be a coordinate in an X-axis direction. The Y coordinate may be a coordinate in a Y-axis direction. The Y-axis direction may intersect the X-axis direction. The controller 230 may transmit the first image IMG1 and the XY coordinates of the exterior defect to the optical coherence tomography device 300.

In an embodiment, the controller 230 may determine the defect of the display device 100 and a defect type of the display device 100 based on the first image IMG1 by a deep machine learning model.

In an embodiment, the defect type may be determined based on the first image IMG1, and the defect type may include an adhesive layer defect, a protrusion defect, a surface foreign substance defect, a scratch defect, and a crack defect, for example. The adhesive layer defect may be a defect caused by creasing the adhesive layer OCA, and may be determined through differential field data. The protrusion defect may be a defect in which glass on an upper end of the window 60 gradually protrudes, and may be determined through the differential field data. The surface foreign substance defect may be a defect in which a floating foreign substance is attached onto the window 60, and may be determined through a field image. The scratch defect may be a defect having a shape in which a surface of the window 60 is scratched, and may be determined through a dark field image. The crack defect may be a defect in which an outer peripheral portion of the window 60 has a crack, and may be determined through a bright field image.

The deep machine learning model may be a model optimized for image classification. The deep machine learning model will be described in detail below.

Since the first image IMG1 is the image of the exterior of the display device 100, the defect inspection performed by the multi-optical vision device 200 may be inaccurate for an inside of the display device 100. According to a conventional defect classification method, after the defect inspection is performed by the multi-optical vision device 200, determination of the defect inspection performed by the multi-optical vision device 200 may be performed by a person to specifically determine whether a defect is a false defect or a true defect by a microscope or the like. In this case, the false defect may be a case where the multi-optical vision device 200 determines fair quality as a defect, and the true defect may be a case where the multi-optical vision device 200 determines a defect as a defect. In addition, when the determination of the defect inspection performed by the multi-optical vision device 200 is made as the true defect, the defect type of the display device 100 may be determined by the person. A substantially long time may be desired when the inspection is performed by the person.

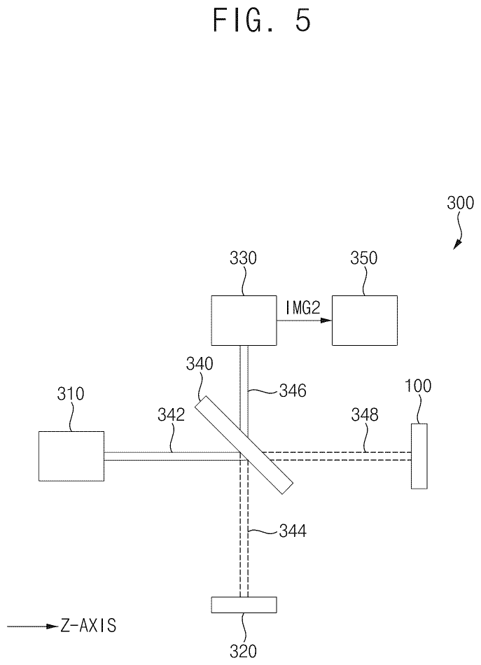

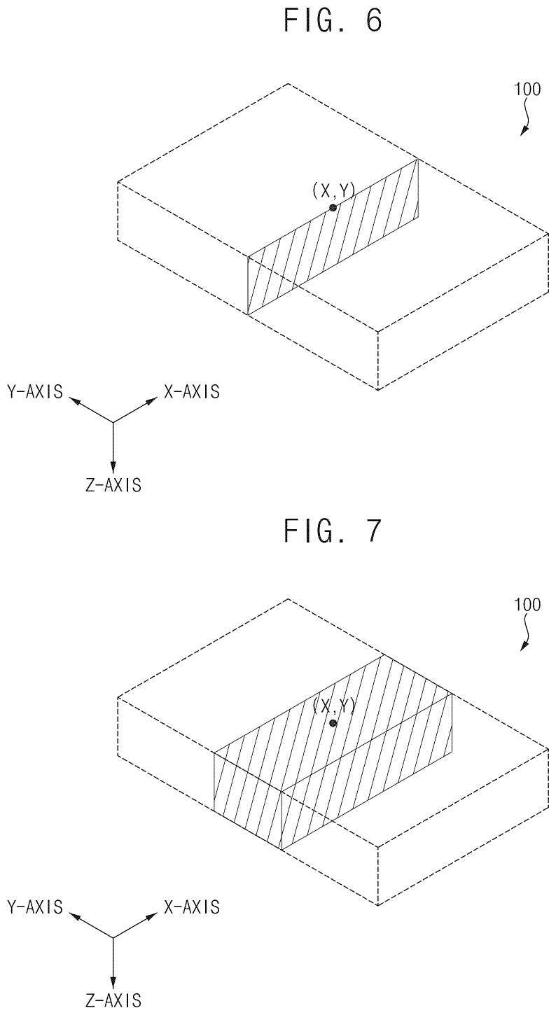

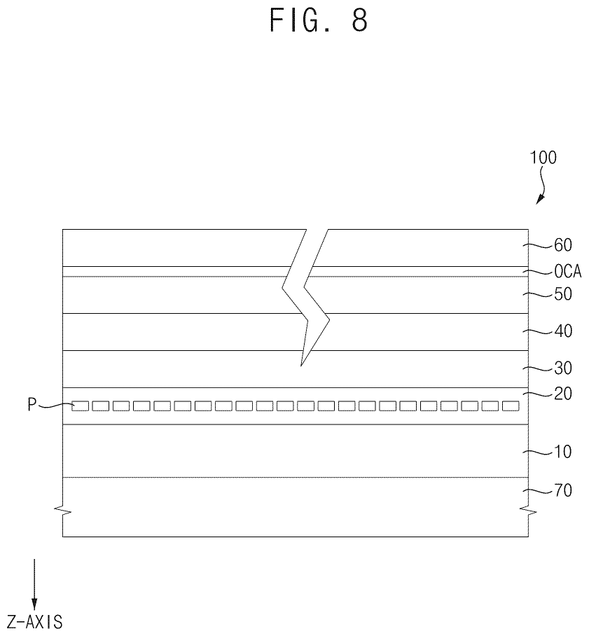

FIG. 5 is a block diagram showing an embodiment of an optical coherence tomography device according to the inventive concept. FIG. 6 is a conceptual diagram showing a B-scan image collected by the optical coherence tomography device of FIG. 5. FIG. 7 is a conceptual diagram showing a C-scan image collected by the optical coherence tomography device of FIG. 5. FIG. 8 is a view showing a second image captured by the optical coherence tomography device of FIG. 5.

Referring to FIGS. 1 to 8, the defect classification method may include: collecting a second image IMG2 of an inside of the display device 100 based on the XY coordinates of the defect of the display device 100 by an optical coherence tomography device 300 (S400); training a deep machine learning model for determining the defect of the display device 100 and a defect type of the display device 100 based on the second image IMG2 by the optical coherence tomography device 300 (S500); determining the defect of the display device 100 based on the second image IMG2 through the deep machine learning model by the optical coherence tomography device 300 (S600); and determining the defect type of the display device 100 based on the second image IMG2 through the deep machine learning model by the optical coherence tomography device 300 (S700).

The optical coherence tomography device 300 may include a second lighting device 310, a reflection plate 320, a detector 330, a beam splitter 340, and a processor 350.

The second lighting device 310 may emit a transmission beam 342 to determine the defect of the display device 100.

The beam splitter 340 may split the transmission beam 342 into a first derivation beam 344 and a second derivation beam 348. The first derivation beam 344 and the second derivation beam 348 may be classified according to a splitting angle of a light. The first derivation beam 344 may be emitted to the reflection plate 320, and reflected from the reflection plate 320. The second derivation beam 348 may be emitted to the display device 100, and reflected from the display device 100. The first derivation beam 344 and the second derivation beam 348 may be emitted back to the beam splitter 340.

The beam splitter 340 may emit an inspection beam 346 including the first derivation beam 344 and the second derivation beam 348. The detector 330 may receive the inspection beam 346, and output the second image IMG2. When the second derivation beam 348 is emitted to the display device 100, the display device 100 may be moved based on the XY coordinates of the defect of the display device 100. The second image IMG2 may be an image determined based on the XY coordinates of the defect of the display device 100. When the optical coherence tomography device 300 performs defect inspection on the entirety of the display device 100, defect inspection efficiency may be low. In order to increase the defect inspection efficiency of the optical coherence tomography device 300, the optical coherence tomography device 300 may inspect a portion of the display device 100 based on the XY coordinates of the defect of the display device 100. As shown in FIG. 8, the second image IMG2 may include information on the display device 100 in a Z-axis direction. The optical coherence tomography device 300 may generate the second image IMG2 by path difference interference of a light. In an embodiment, the second image IMG2 may be a B-scan image, and the B-scan image may be a two-dimensional image as shown in FIG. 6. In another embodiment, the second image IMG2 may be a C-scan image, and the C-scan image may be a three-dimensional image as shown in FIG. 7. A longer execution time may be desired for the C-scan image than that of the B-scan image. The C-scan image may have higher accuracy of the defect inspection than that of the B-scan image.

The processor 350 may receive the first image IMG1 from the controller 230, and may receive the second image IMG2 from the beam splitter 340. In an embodiment, the processor 350 may determine the defect of the display device 100 and the defect type of the display device 100 based on the second image IMG2. In another embodiment, the processor 350 may determine the defect of the display device 100 and the defect type of the display device 100 based on the first image IMG1 and the second image IMG2.

In an embodiment, when the processor 350 determines that the display device 100 does not include the defect based on the second image IMG2, the defect inspection of the display device 100 may be terminated.

The processor 350 may determine that the display device 100 includes the defect based on the first image IMG1 and/or the second image IMG2. The processor 350 may train the deep machine learning model for determining the defect of the display device 100 and the defect type of the display device 100 based on the first image IMG1 and/or the second image IMG2.

Deep machine learning may refer to a technology in which an electronic device performs learning by combining and analyzing data to form a rule by itself. A deep machine learning algorithm may be a neural network. The neural network may be a set of algorithms for learning a method for recognizing an object from a predetermined image input to the neural network based on artificial intelligence (“AI”). In an embodiment, the neural network may learn the method for recognizing the object from the image based on supervised learning using the image as an input value, for example. In an embodiment, the neural network may learn the method for recognizing the object from the image based on unsupervised learning for finding a pattern for recognizing the object from the image by learning a type of data desired to recognize the object from the image by itself without any supervision. In addition, the neural network may learn the method for recognizing the object from the image by reinforcement learning using feedback on whether a result of recognizing the object according to the learning is correct, for example.

In addition, the neural network may perform a calculation for inference and prediction according to an AI technology. In detail, the neural network may be a deep neural network (“DNN”) for performing a calculation through a plurality of layers. When a plurality of layers are provided, that is, when a depth of the neural network for performing a calculation is increased, according to the number of the layers for performing calculations in the neural network, the neural network may be classified as the DNN. In addition, a calculation of the DNN may include calculations of a convolutional neural network (“CNN”) or the like. The CNN may include a U-NET network or the like. In other words, the processor 350 may implement a data recognition model for recognizing an object through the exemplified neural network, and train the implemented data recognition model by training data. In addition, the processor 350 may analyze or classify an image, which is data that is input, by the trained data recognition model so as to analyze and classify what the object included in the image is.

In the illustrated embodiment, the deep machine learning algorithm may be the CNN. Three layers including a convolutional layer, a pooling layer, and a fully connected (“FC”) layer of the CNN may be used. The CNN may reduce an amount of data of the image and extract features robust against distortion of the image by repeatedly performing convolution and sub-sampling by the convolutional layer and the pooling layer, respectively, while moving a mask having a weight. In addition, the CNN may extract a feature map through the convolution, and classify the object having the defect (a foreign substance, a scratch, etc.). The sub-sampling may be a process of reducing a screen size. In an embodiment, the pooling layer may be a max pooling layer for selecting a maximum value in a corresponding region, for example. In an embodiment, the pooling layer may be an average pooling layer for selecting an average value of the corresponding region in the corresponding region, for example. In an embodiment, the corresponding region may be a two-by-two (2×2) region, for example.

As described above, according to the defect classification method and the defect classification system, by the multi-optical vision device 200, the defect of the display device 100 may be determined based on the first image IMG1 of the exterior of the display device 100, and the XY coordinates of the defect of the display device 100 may be extracted; and by the optical coherence tomography device 300, the deep machine learning model for determining the defect of the display device 100 and the defect type of the display device 100 may be trained based on the XY coordinates of the defect of the display device 100 and the second image IMG2 of the inside of the display device 100.

Accordingly, the defect inspection and the defect classification may be performed rapidly and simply by the multi-optical vision device 200. When the defect of the display device 100 is suspected, additional defect inspection and defect classification may be thoroughly performed by the optical coherence tomography device 300. The defect inspection and the defect classification performed by the optical coherence tomography device 300 may use the deep machine learning model, so that accuracy of the defect inspection and the defect classification may be increased, and a time desired for the defect inspection and the defect classification may be reduced.

What is claimed is:

1. A defect classification method comprising:
collecting a first image of an exterior of a display device by a multi-optical vision device;
determining a defect of the display device based on the first image by the multi-optical vision device;
extracting XY coordinates of the defect of the display device;
collecting a second image of an inside of the display device based on the XY coordinates of the defect of the display device by an optical coherence tomography device;
training a deep machine learning model for determining the defect of the display device and a defect type of the display device based on the second image by the optical coherence tomography device;
determining the defect of the display device based on the second image through the deep machine learning model by the optical coherence tomography device; and
determining the defect type of the display device based on the second image through the deep machine learning model by the optical coherence tomography device.

2. The defect classification method of claim 1, wherein, when it is determined that the display device does not include the defect based on the first image by the multi-optical vision device, defect inspection for the display device is terminated.

3. The defect classification method of claim 1, wherein, when it is determined that the display device does not include the defect based on the second image by the optical coherence tomography device, defect inspection for the display device is terminated.

4. The defect classification method of claim 1, wherein the deep machine learning model for determining the defect of the display device and the defect type of the display device is trained based on the first image and the second image by the optical coherence tomography device.

5. The defect classification method of claim 1, wherein the deep machine learning model includes a convolutional neural network.

6. The defect classification method of claim 5, wherein the convolutional neural network includes a convolutional layer, a pooling layer, and a fully connected layer.

7. The defect classification method of claim 6, wherein the pooling layer includes a max pooling layer.

8. The defect classification method of claim 6, wherein the pooling layer includes an average pooling layer.

9. The defect classification method of claim 1, wherein the second image includes information on a foreign substance and layers in a stacked structure of the display device.

10. The defect classification method of claim 1, wherein the second image includes a B-scan image.

11. The defect classification method of claim 1, wherein the second image includes a C-scan image.

12. The defect classification method of claim 1, wherein the defect of the display device and the defect type of the display device are determined based on the first image through the deep machine learning model by the multi-optical vision device.

13. A defect classification system comprising:
a multi-optical vision device which collects a first image of an exterior of a display device, determines a defect of the display device based on the first image, and extracts XY coordinates of the defect of the display device; and
an optical coherence tomography device which collects a second image of an inside of the display device based on the XY coordinates of the defect of the display device, trains a deep machine learning model for determining the defect of the display device and a defect type of the display device based on the second image, determines the defect of the display device based on the second image through the deep machine learning model, and determines the defect type of the display device based on the second image through the deep machine learning model.

14. The defect classification system of claim 13, wherein the deep machine learning model for determining the defect of the display device and the defect type of the display device is trained based on the first image and the second image by the optical coherence tomography device.

15. The defect classification system of claim 13, wherein the deep machine learning model includes a convolutional neural network.

16. The defect classification system of claim 15, wherein the convolutional neural network includes a convolutional layer, a pooling layer, and a fully connected layer.

17. The defect classification system of claim 16, wherein the pooling layer includes a max pooling layer.

18. The defect classification system of claim 16, wherein the pooling layer includes an average pooling layer.

19. The defect classification system of claim 13, wherein the second image includes information on a foreign substance and layers in a stacked structure of the display device.

20. The defect classification system of claim 13, wherein the second image includes a B-scan image.
